(19) United States
(12) Patent Application Publication
(10) Pub. No.: US 2007/0114258 A1
(43) Pub. Date: May 24, 2007

(54) COUPON ORGANIZER WITH TABBED POCKETS

(76) Inventor: Ellen J. Miller, Pepper Pike, OH (US)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/467,606

(22) Filed: Aug. 28, 2006

Related U.S. Application Data
(60) Provisional application No. 60/711,467, filed on Aug. 26, 2005.

(51) Int. Cl. B60R 7/00; B60R 9/00

(52) U.S. Cl. 224/411

(57) ABSTRACT

A purse-like container includes a housing having a hollow interior, an accordion file in the container with labels to facilitate storing and retrieving shopping coupons. A top wall of the purse-like container covers the open top of the container and accordion file to stop the coupons from falling out. The top wall can be folded over toward the back of the container and fastened thereto and about the handle of a shopping cart to suspend the container in convenient position for easy access during shopping. A method of shopping includes suspending a purse-like container from the handle of a shopping cart, wherein the purse-like container has a number of coupons organized in a manner to facilitate coordinating access to the coupons with possible items for purchasing.

### CROSS-REFERENCE TO RELATED APPLICATION

This application claims the benefit of U.S. Provisional Patent Application Ser. No. 60/711,467, filed Aug. 26, 2005, the entire disclosure of which is hereby incorporated by reference.

### TECHNICAL FIELD

The present invention relates generally, as indicated, to a COUPON ORGANIZER WITH TABBED POCKETS. The invention also relates to a method of maintaining coupons in an orderly fashion and of conveniently accessing the coupons during a shopping experience.

### BACKGROUND

Coupons for obtaining reduced prices for various goods and services have been multiplying significantly in modern times. Coupons are distributed to encourage prospective purchasers to purchase a given item or service at a discounted price or with the inclusion of a premium. Coupons are distributed by publishing them in newspapers, magazines and other media. Coupons are distributed via individual mailers with a single coupon or in a coupon package that includes a number of coupons. Coupons also readily are available via the internet, whereby a coupon can be downloaded and printed by an individual.

Many times coupons are collected in a stack by an individual. The coupons may be from many different products and services; some coupons may be redundant, e.g., for the same product with the coupons having a limitation of one per product or per shopping trip, etc. Sometimes coupons are expired or soon-to-expire, and, of course it is desirable to facilitate use of a soon-to-expire coupon before expiration to obtain maximum advantage of coupon collection efforts of that individual. It is easy to accumulate many coupons over a relatively short period of time, but it is difficult and time consuming to sort the coupons to facilitate timely use of the coupons and maximum advantage of use. Sometimes two coupons may be obtained for a given product; the coupons may be for different values to the individual user, usually it is advantageous to use the coupon that has the higher value to achieve maximum price discount.

Prior coupon wallets have existed. Prior coupon wallets typically are of a size that is adequate to hold a stack of coupons. However, each time an individual wants to use a coupon, the individual would have to finger through the coupons in the wallet to find a desired coupon. Sometimes a user may take a shopping cart filled with groceries to the checkout counter and then scan through the coupons in a stack of them contained in a wallet to try to find those coupons that may be applicable to the goods in the shopping cart. This takes time (many individuals prefer not to spend time standing in line), and it is too easy to miss a pertinent coupon as the coupons hastily are reviewed.

Thus, there is a need for organizing and storing coupons. There is also a need to facilitate using coupons.

### SUMMARY

An aspect of the invention relates to a purse-like container, including a housing having a hollow interior therein having an open area at or near the top; a movable top wall portion for the hosing movable between respective open and closed position relation to open access to the hollow interior and to cover the open area, respectively; and wherein the movable top wall portion is adapted in a closed position to block the release of removable contents within the hollow interior; and wherein the movable top wall portion is adapted in a open position to be fastened to a wall of the housing to mount or to suspend the housing from a support while providing access to the hollow interior. Another aspect relates to a method of shopping, including suspending a purse-like container from the handle of a shopping cart, wherein the purse-like container has a number of coupons organized in a manner to facilitate coordinating access to the coupons with possible items for purchasing.

To the accomplishment of the foregoing and related ends, the invention comprises the features hereinafter fully described and particularly pointed out in the claims. The following description and the annexed drawings set forth in detail certain illustrative embodiments of the invention. These embodiments, however, are merely indicative of a few of the various ways in which the principles of the invention may be employed. Other objects, advantages and novel features of the invention will become apparent from the following detailed description of the invention when considered in conjunction with the drawings.

Although the invention is shown and described with respect to one or more preferred embodiments, it is obvious that equivalents and modifications will occur to others skilled in the art upon the reading and understanding of the specification. The present invention includes all such equivalents and modifications, and is limited only by the scope of the claims. Also, it will be appreciated that embodiments, features and parts shown and/or described in one drawing figure may be used with embodiments, features and/or parts shown and/or described in one or more other drawing figures.

### BRIEF DESCRIPTION OF THE DRAWINGS

In the annexed drawings:

FIG. 1 is an isometric front view of the coupon organizer with the cover open and folded back;

FIG. 2 is an isometric front view of the coupon organizer with the cover closed;

FIG. 3 is an isometric back view of the coupon organizer with the cover up standing;

FIG. 4 is an isometric back view of the coupon organizer with the cover coupled about a support bar;

FIG. 5 is an isometric side view of the coupon organizer with the cover closed;

FIG. 6 is an isometric side view of the coupon organizer with the cover coupled about a support bar;

FIG. 7 is a cross section side view of the coupon organizer with the cover open;

FIG. 8 is a cross section side view of the coupon organizer with a number of coupon-holding compartments;

FIG. 9 is a fragmentary side isometric view of a number of coupon holding compartments arranged as an accordion-type file or wallet;

FIG. 10 is a fragmentary side isometric view of a number of accordion wallets;

FIG. 11 is a fragmentary side isometric view of several accordion wallets fastened together;

FIG. 12 is a fragmentary isometric side view of a coupon holding compartment having a label portion;

FIG. 13 is an isometric side view of a coupon holding compartment having a label/card holding channel; and

FIG. 14 is a schematic illustration of a coupon organizer kit.

### DESCRIPTION

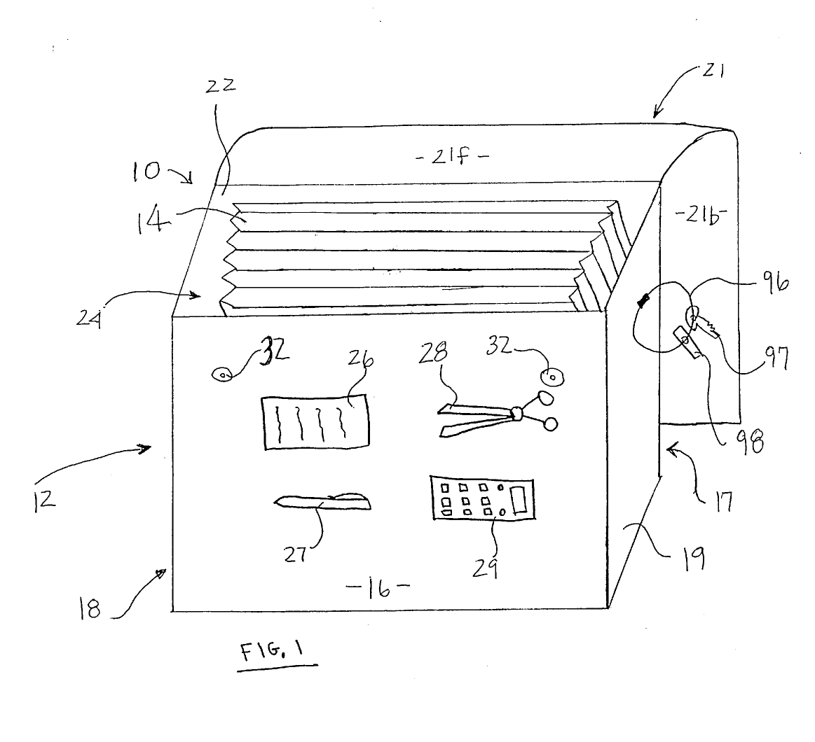

Referring to the drawings, wherein like reference numerals designate like parts in the several figures, and initially to FIG. 1, a coupon organizer 10 is illustrated. The coupon organizer 10 includes a purse-like container or housing 12 and coupon holding components or compartments 14. The housing 12 has front, back, sides, bottom and top wall portions 16-21, as is illustrated in the drawing. The housing 12 has a hollow interior or in any event a relatively vacant interior area 22 within which the coupon holding components 14 may be located. The top 24 of the hollow interior 22 is open to provide access to the coupon holding components 14 and to the coupons therein and/or to other devices that may be retained or stored in the housing 12, such as, for example, a pad 26, a pen 27, scissors 28, calculator 29, etc.

The pad 26 may be formatted with a number of lines preprinted on it to facilitate writing a shopping list. The pad may include printed on it a number of usual shopping items, such as, for example, bread, milk, juice, eggs, etc. The several items 26-29 may be loosely placed in the interior 22 of the housing 12 or may be held in a separate holder pocket or component similar to or different from the coupon holding components 14, as may be desired. An example of such a holder may be similar to a small wallet, cosmetics bag, etc., that typically may be used to hold several devices such as the pad, pen, scissors, calculator, etc., so they are not loosely placed individually in the interior 22 of the housing 12 but rather are collected in such cosmetic bag type device or the like.

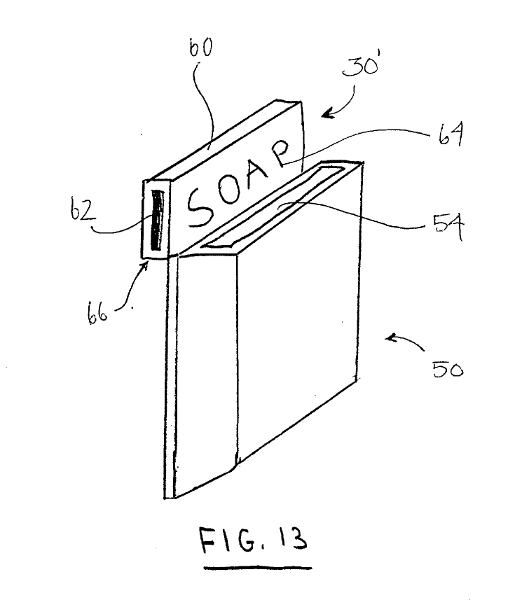

The coupon holding components 14 are described further below with respect to several other drawing figures. The coupon holding components are provided to hold in separate pockets, file folder-like spaces, etc., coupons that are directed to separate respective types of items for which a person may be shopping in a supermarket or other store, for example. As is illustrated in FIG. 1, several of those types of food or other items are written on the label portion 30 (see FIG. 12, for example) of respective coupon holding components 14, such as, for example, soap, sauce, pasta, etc. Also, on the label portion 30 of one of the coupon holding components 14 is written “shopping list, pen, tools, calculator” and that coupon holding component may be employed, for example, to hold in a single location within housing 12 the pad 26, pen 27, scissors 28, and calculator 29 instead of retaining those parts in a separate cosmetic bag-like device or the like.

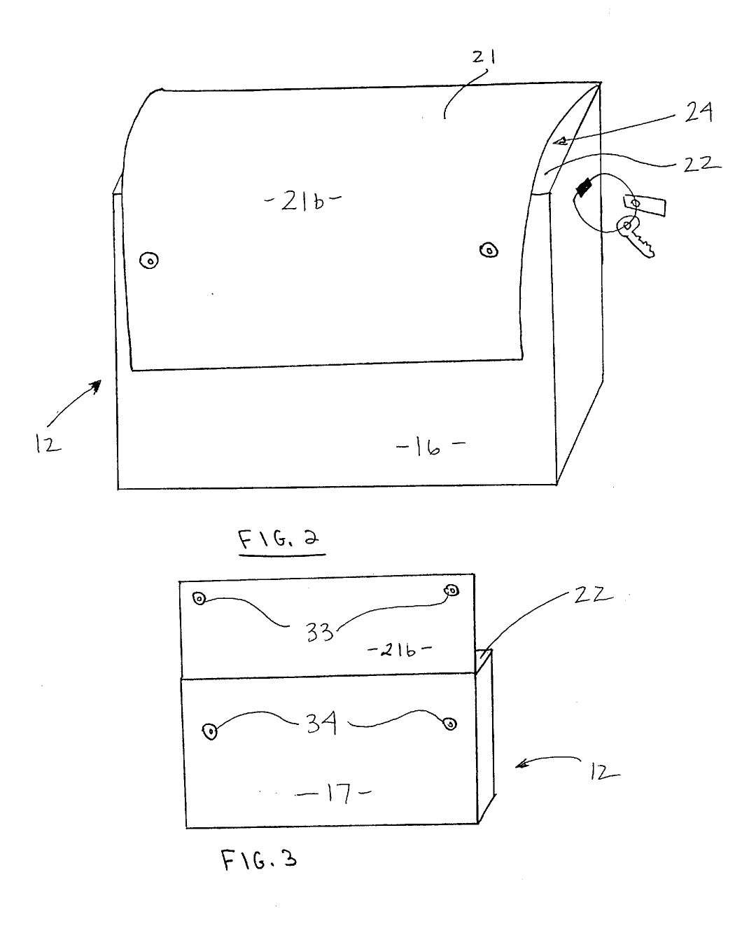

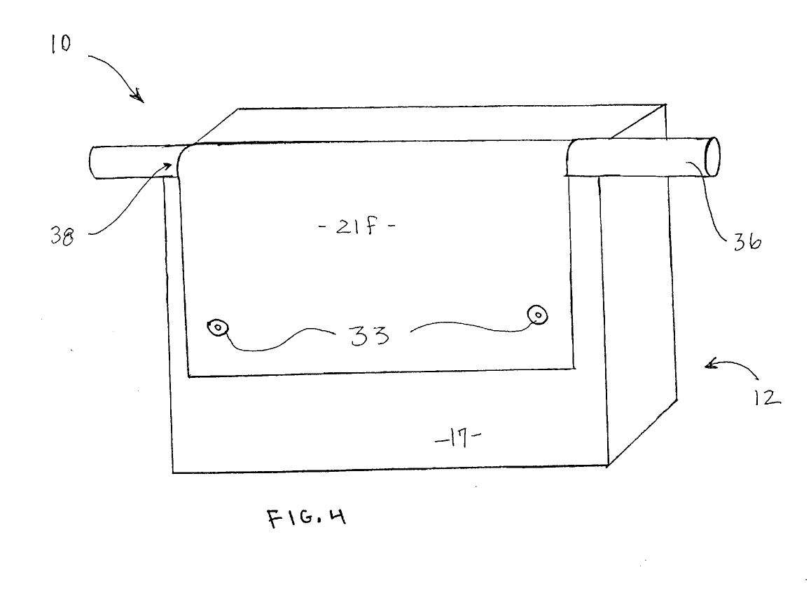

The top wall (also referred to as cover) 21 of the housing 12 is illustrated in FIG. 1 in an open position and in FIG. 2 in a closed position. In open position the top 24 of the housing 12 is open to provide access to the coupons or the like in the coupon holding components 14. In the closed position of FIG. 2 the top wall 21 closes the top 24 of the housing interior 22 as a cover to prevent the coupon holding components 14, coupons, devices 26-29, etc., from falling out of the housing 12.

The housing 12 may be made of fabric material. It also or alternately may be made of leather, plastic, or some other material. In the illustrated embodiment the housing 12 is made of fabric material. The top 21 may is part of the back 17 as an integral piece of material or it may be separately attached to the back or to some other part(s) of the housing 12, as by sewing, gluing, or some other means. The top 21 is flexible and may be folded in the manner illustrated in FIG. 1 to allow the open top 24 of the interior 22 easily to be accessible by a user of the coupon organizer 10; or the top 21 may be folded over to close the hollow interior 22 in the manner illustrated in FIG. 2, for example. If desired, the top 21 may be attached to the back 17 of the housing 12 by a hinge or by some other mechanism. Also, as desired the back may be attached to sides 18 and/or 19 and/or may be otherwise attached to various parts of the housing 12. If desired, several of the front, back, sides, bottom and/or top of the housing 12 may be formed of a single piece of fabric cut and sewn to the shape illustrated in the drawings or in some other shape to provide the interior space 22 for holding coupons in coupon holding components 14. Alternatively, one or more of those parts may be separate and may be attached to one or more other parts to form the housing 12 by sewing, stapling, gluing or some other means.

The coupon organizer 10 has a number of fasteners 32 on the front 16 of the housing 12. A number of fasteners 33 are provided on the top 21, and a number of fasteners 34 are provided on the back 17 of the housing.

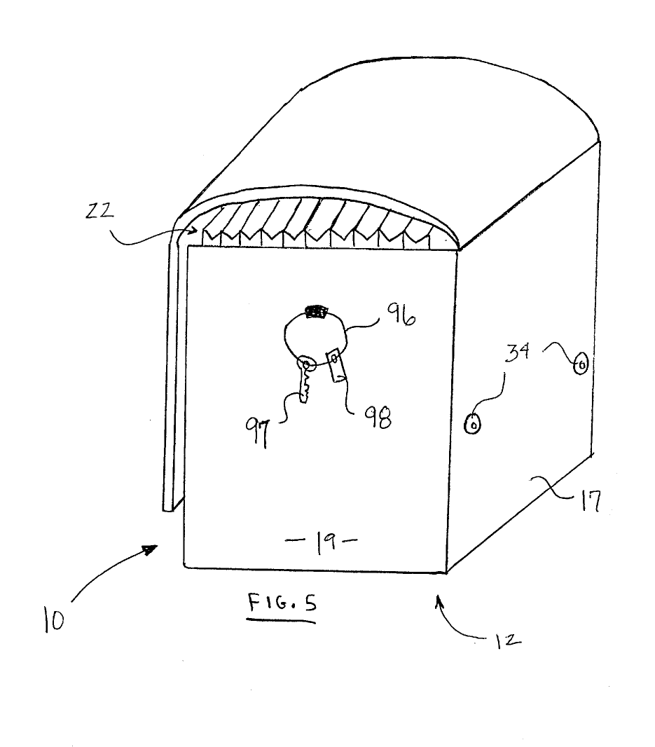

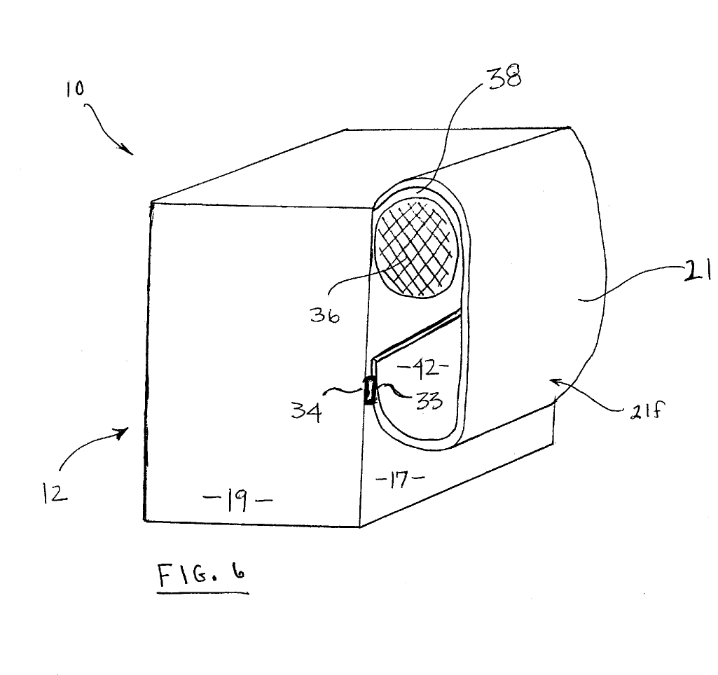

The cover 21 and the fasteners 32, 33 and 34 and those portions of the housing to which the fasteners are attached, e.g., the front and back wall portions 16, 17, cooperate to provide dual functions for the cover 21, namely to close the top 24 as is illustrated in FIGS. 2 and 5 of the hollow interior 22 of the housing 12 (and the fasteners are used to hold the cover in that closed position), and to mount or to suspend the housing from a support 36, e.g., as is illustrated in FIGS. 4 and 6. In the closed position of the cover 21, the fasteners 32 and 33 may couple with each other to hold the cover closed. To provide the suspending function to hold the coupon organizer 10 to a support 36, e.g., bar, rod, etc., such as, for example, to the handle of a conventional shopping cart used in a supermarket or the like, the fasteners 33 and 34 may interact or interconnect to hold the cover in the orientation illustrated in FIGS. 4 and 6.

The fasteners may be conventional snap fasteners, whereby, for example, the fasteners 33 on the cover have a male-like protrusion and the snap fasteners 32, 34 are resilient female type receptacles for those protrusions. Conventional fasteners of this type are used often for fastening clothing garments and for other purposes. The fasteners may be attached to the housing material by crimping, riveting or even a sewing type process. Other types of fasteners may be used, for example, buttons, other types of snaps, velcro-type fasteners, adhesive type fasteners, and/or other types.

In using the relatively versatile cover 21 for the coupon organizer 10, the cover may be moved to the closed position shown in FIG. 2, for example, whereby the fasteners 32, the front 16 and the fasteners 33 on the cover 21 interengage and hold the cover closed. The cover also may be reverse folded in the manner illustrated in FIG. 4 so that a loop 38 is formed by the cover 21. The loop 38 may be formed in such a way that a support bar or support rod 36 can be located within the area of the loop. The cover 21 and the loop 38 then may be used to support the coupon organizer 10 from the support bar, rod, etc., e.g., the handle of a shopping cart.

The fasteners 32, 33, 34 cooperate in the following manner. The fasteners 32 and 33 may be connected to hold the cover 21 closed. The fasteners 33, 34 may be fastened together to form the loop 38 to mount the coupon organizer 10 to a support 36, such as a bar, rod, handle, etc. The fasteners 33 may be accessible either from the back surface 21b of the cover 21 or from the front surface 21f of the cover 21. If desired, a type of fastener 33 may be used that is accessible from both the front 21f and back 21b of the cover 21. Alternatively, the fasteners 33 may include one or more fasteners that is accessible to provide fastening function from the front 21f and additional fasteners that provide fastening function accessible from the back 21b of the cover; in such case there would be a duplication of fasteners 33, some on the front and some on the back of the cover 21. Other arrangements of fasteners also may be used.

As is illustrated in FIG. 4, fasteners 33 are of the type that are accessible from both the front 21f and the back 21b of the cover 21. In this case the fasteners 33 on the back 21b are attached or fastened to the fasteners 34, which are on the back 17 of the housing 12, thereby to hold the cover in position relative to the back while forming the loop 38. The front portion of the fasteners 33, which are seen at the front 21f in FIG. 4 may be used to fasten or to attach to the fasteners 32 on the front 16 of the housing 12 (the fasteners 32 are shown in FIG. 1, for example).

Briefly referring to FIG. 6, another method or approach to fasten the cover 21 to fasteners 34 on the back 17 of the housing 12 is illustrated in this embodiment the fasteners 33 are on the front of the cover 21, and the cover 21 is looped over at the area 42 to allow for fastening of the fasteners 33 to the fasteners 34, thus forming a loop 38 to attach or to couple with respect to a support rod 36.

For the foregoing, then it will be appreciated that the cover 21 and fasteners 32, 33, 34 may be used in a number of ways to cover the interior 22 of the housing 12 and to suspend the housing 12, indeed, to suspend the entire coupon organizer 10, from a support in the way of a rod, bar, handle or some other support.

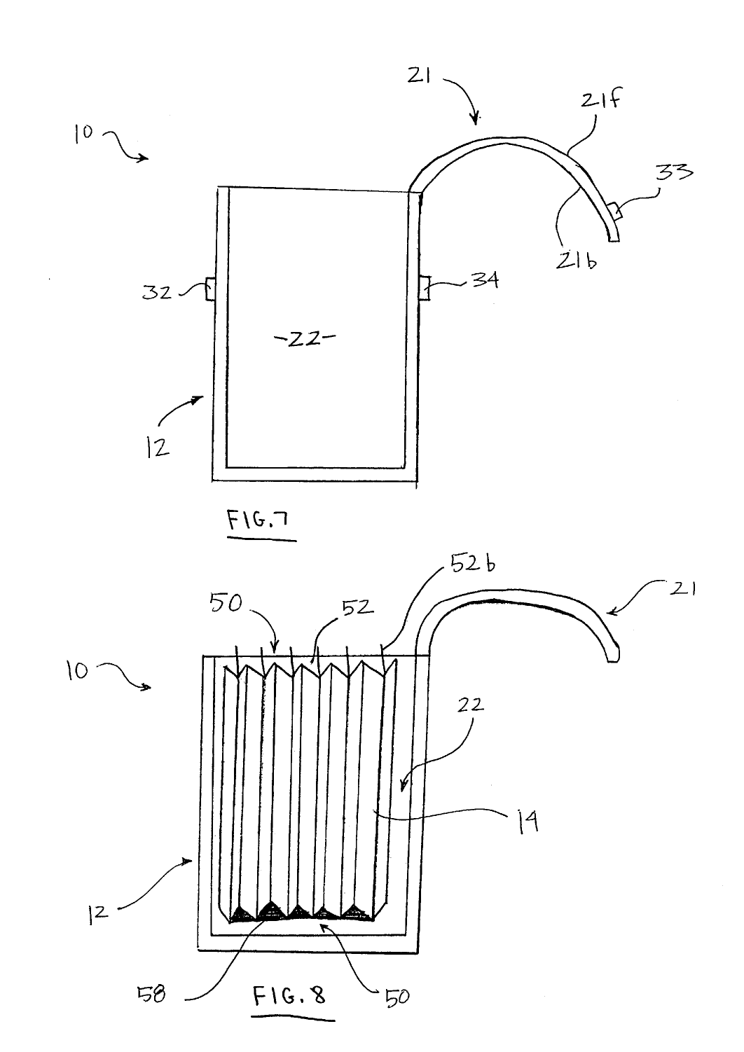

Turning, now to FIGS. 7-11, the arrangement of coupon holding components 14 with respect to the housing 12 of the coupon organizer 10 are illustrated. As the seen in FIG. 7, the hollow interior 22 of the housing 12 is illustrated. No coupon holding components 14 are shown in FIG. 7. However, in FIG. 8 a coupon holding component 14 is illustrated. The coupon holding component 14 includes a number of pocket-like or file-like units 50, each of which has a storage area 52 and a label portion 30. The storage area 52 is a space between a pair of front and back pocket walls. The label portion 30 may be an extension of the back wall 52b and may include a surface on which the user may write information, such as, for example, the type of coupon that may be inserted in that pocket and be found conveniently when needed. Exemplary types of coupons may be those for specific food items, those for specific clothing items, etc. The tops 54 of the pockets are open so that the storage area 52 is accessible. The bottoms 56 of the pockets are closed so the coupons do not fall out. The bottoms 56 may be attached together by a retainer 58. The retainer 58 may be adhesive, a string or spring, or some other mechanism to hold the pockets 50 together respect to each other to form a stack of pockets, as are illustrated in FIG. 8, for example, so that the attached pockets easily may be inserted as a group into the interior 22 of the housing 12 and/or removed therefrom, as may be desired. The pockets 50 may be interconnected as a type of accordion-type file, as often as used to store a number of different papers relating to a given matter. Such conventional files usually are made of paper or cardboard. Although the pockets of the present invention may be formed of paper or cardboard, they also may be formed of plastic or of some other material.

As was mentioned above, the label portions 30 of respective pockets may be made of a material on which the user may write information. Alternatively, the label portions 30 may be pre-printed with information. These possibilities are illustrated in FIG. 12, for example. In FIG. 13 a different form of label portion 30′ is illustrated for a pocket 50. The label portion 30′ includes a holder 60 for a label, card, slip of paper 62 or the like, on which information 64 may be written, printed, etc. The label, card, the comments that may placed in a hollow channel 66 that is in the holder 60. The label may be removed from the channel and be replaced, as may be desired, e.g., to provide a label with different information on it, to write a clean or undamaged label, etc.

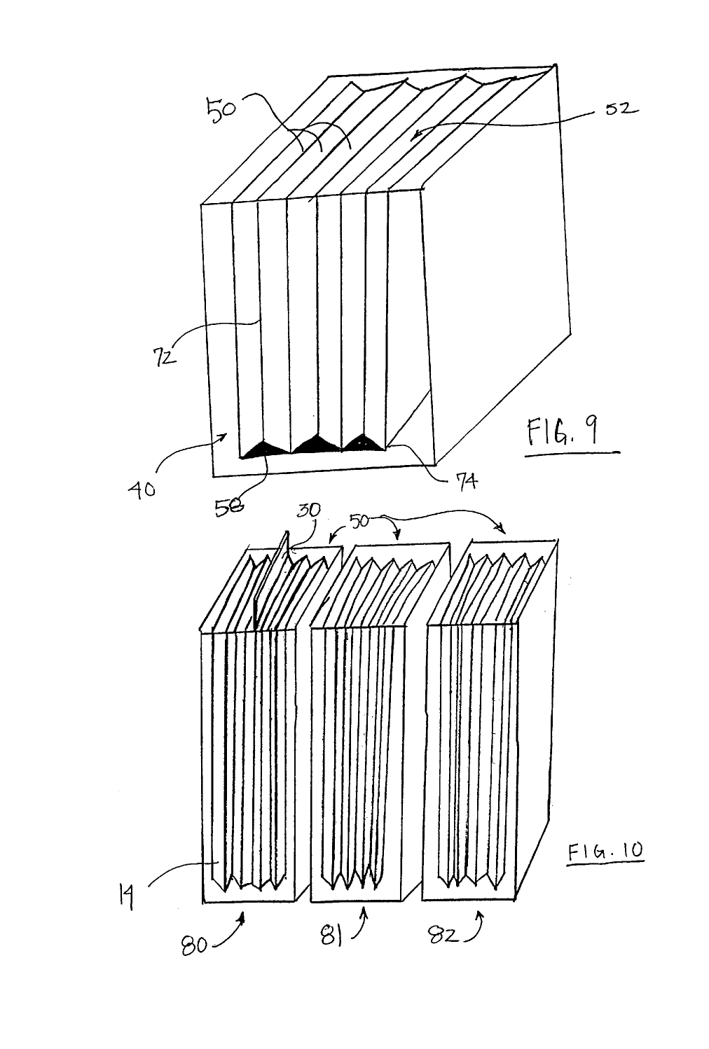

An enlarged fragmentary view of an accordion-type or a multi-compartment wallet-type coupon holding component 40 having a number of pockets 50 is illustrated in FIG. 9. The accordion/wallet type of coupon holding component 14 includes a number of pockets 50 that are fastened together or otherwise formed to hold the pockets together in an accordion-type fashioned whereby the side walls 72 and bottom walls 74 have walls that fold or bend in an appropriate manner like an accordion to enlarge or to reduce the space in the storage areas 52 of respective pockets 50. The bottoms 74 are fastened together or are formed as an integral structure or are held by retainer 58 to form a single unit having a number of respective pockets.

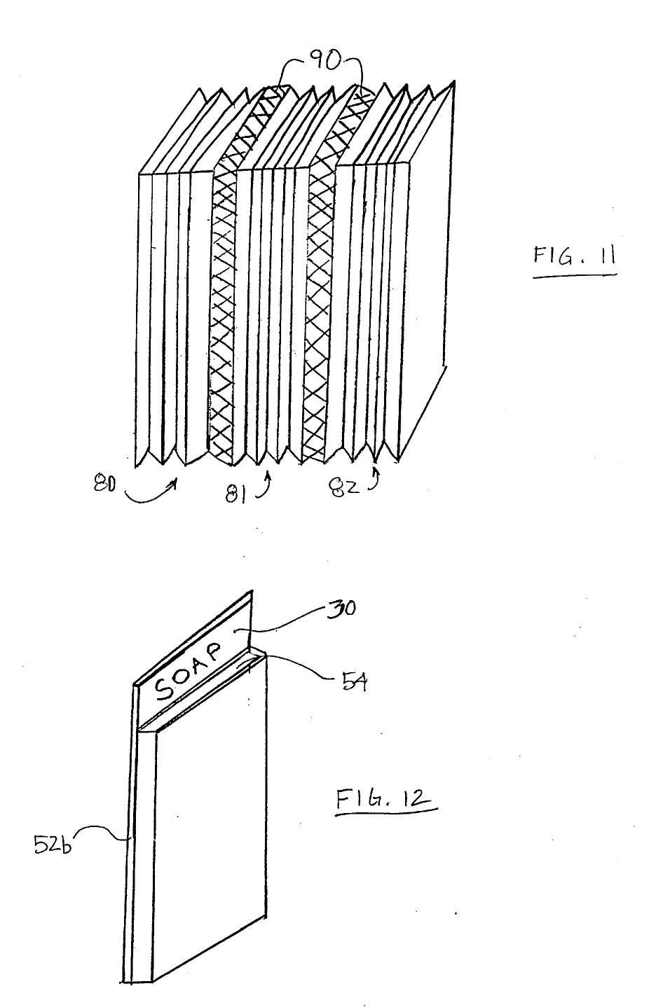

In FIG. 10 are illustrated several accordion-type or wallet-type (sometimes referred to as accordion wallet) units 80, 81, 82, each of which includes a number of pockets 50. A label portion 30 is illustrated on one of the groups of pockets, e.g., the unit 80. It will be appreciated that label portions 30 may be on more than one or on none of the respective pockets 50 of the units 80, 81, 82, as may be desired. The units 80, 81, 82 may remain separate from each other, on the one hand, and may all be placed in the hollow interior 22 of the housing 12 of the coupon organizer 10, for example, as is illustrated in FIGS. 7 and 8. Using separate units 80, 81, 82, etc., one unit may be specified for dairy products, one for fruits and vegetables, one for frozen foods, another for meats, another for cleaning products, etc. If desired, each of those individual units 80-82 may be removed from the coupon organizer 10 and used individually, e.g., for placing coupons in respective pockets, for removing coupons from those pockets, etc. Also, if a number of units 80-82, etc., become rather full such that it is difficult to fit all the units in the interior 22 of the housing 12, then one of the units could be removed, leaving more space for the other units and easier to access the individual pockets 50 of those remaining units.

In FIG. 11 is illustrated an example of a number of units 80-82 attached together using a fastener 90. The fastener 90 may be adhesive, double sided adhesive tape, glue, rivets, or some other mechanism.

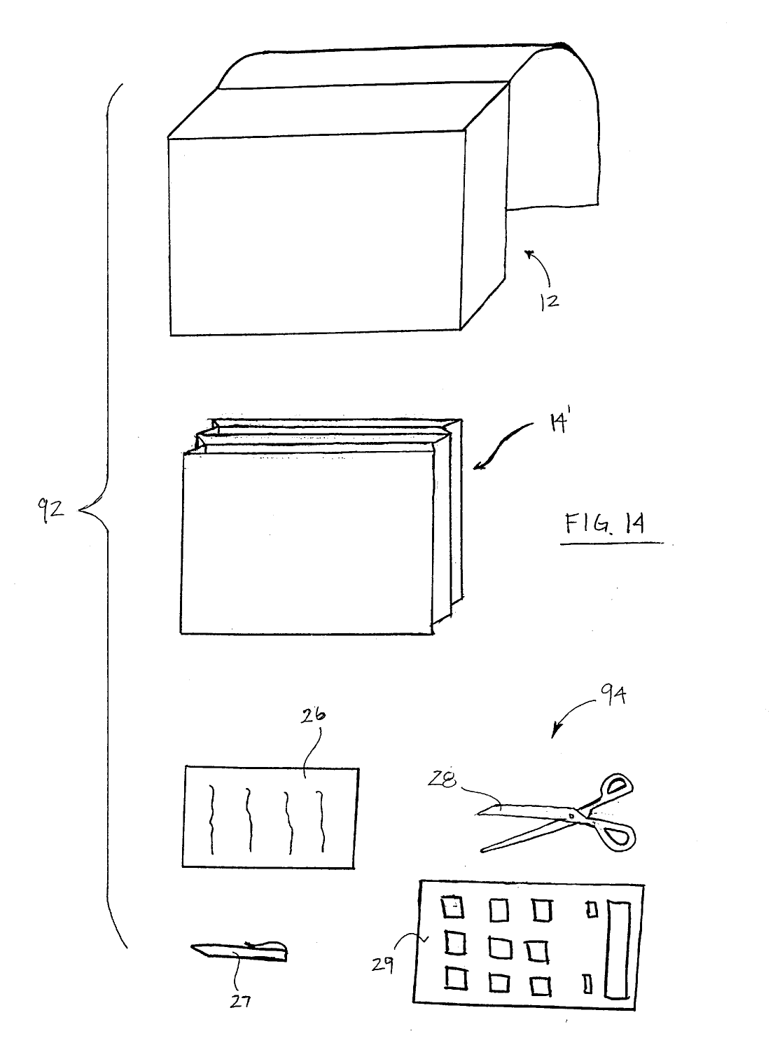

In FIG. 14 is illustrated a coupon organizer kit 92. The coupon organizer kit 92 includes a housing 12, a coupon holding component 14′, and a number of utensils or devices 94, such as a pad 26, pen 27, scissors 28, calculator 29, and/or other devices that may be useful, particularly while a person is shopping in a supermarket or elsewhere or in preparation therefor. The pad and pen may be used to write a shopping list; e.g., a list of goods to be purchased at a store. The scissors may be used to cut coupons. The calculator may be used to add prices and to determine the most cost effective purchasing routine, e.g., whether to purchase a large size of a given item or two of the smaller size packages of that item, etc. The coupon holding component 14′ may be like those described above. It is shown as an accordion wallet illustrated in FIG. 9. However, it will be appreciated that other types of coupon holding components may be used, such as those described and illustrated herein.

In using the coupon organizer 10 of the present invention, a person would place coupons in the respective pockets 50 according to an organization determined by the user, such as, for example, according to the type of product, or a particular brand, etc. The user may take the coupon organizer to a supermarket while the cover 21 is closed so coupons will not fall out. The user may unfasten the cover 21 to open the interior of the housing from the orientation or position in which the cover closes the top of the interior 22 of the housing 12. In that closed position, the cover helps prevent the coupons from falling out of the housing. The user may wrap the cover about the handle of a shopping cart and may attach the fasteners 33 of the cover 21 to fasteners 34 of the back portion 17 of the housing 12, thus forming the loop 38 about the handle 36 (FIG. 4 and/or FIG. 6). The coupon organizer then remains attached to the handle of the shopping cart while providing ready access, relatively unimpeded access to the coupons that are organized and held within the pockets 50 of the coupon holding component(s) 14 that is in the housing 12.

As is illustrated in several of the drawings, a retainer, such as, for example, a spring clip or the like, may be attached to a side wall 19 or to some other portion of the housing 12 to hold a key ring 96 with one or more keys 97, identification tag 98, etc.

From the foregoing, then, it will be appreciated that the coupon organizer of the present invention may be used to organize coupons, to store coupons, and to facilitate storing and retrieving coupons in an efficient manner for such organization purposes and for use of the coupons during shopping, etc. The coupon organizer provides for retaining the coupons so that they do not get lost or fall out of the coupon organizer. The coupon organizer also provides for convenient, efficient mounting of the coupon organizer for facile use during shopping in a supermarket and/or other times. Moreover, the coupon organizer may be mounted on a belt instead of on a rigid bar, handle, etc., or on some other manner similar to the way described herein for convenient use.

What is claimed is:

1. A purse-like container, comprising:
a housing having a hollow interior therein having an open area at or near the top;
a movable top wall portion for the hosing movable between respective open and closed position relation to open access to the hollow interior and to cover the open area, respectively; and
wherein the movable top wall portion is adapted in a closed position to block the release of removable contents within the hollow interior; and
wherein the movable top wall portion is adapted in a open position to be fastened to a wall of the housing to mount or to suspend the housing from a support while providing access to the hollow interior.

2. The purse-like container of claim 1, wherein the housing includes a divider to hold store coupons; and
wherein with the top wall in open relation to the housing and fastened to a back of the housing a hanger is formed to hang the purse-like container from the handle of a shopping cart.

3. The purse-like container of claim 1, wherein the movable top wall portion is foldable.

4. The purse-like container of claim 1, wherein the movable top wall portion is flexible.

5. The purse-like container of claim 1, wherein there is at least one fastener attached to the back of the housing; and
at least one fastener attached to the top wall portion.

6. The purse-like container of claim 5, wherein the fastener is a snap.

7. The purse-like container of claim 1, further comprising a snap on the front of housing to hold the top wall closed.

8. The purse-like container of claim 1, wherein the hollow interior holds removable devices, comprising:
at least one accordion type coupon holding component.

9. The purse-like container of claim 8, wherein the accordion type coupon holding component is clear plastic.

10. The purse-like container of claim 8, wherein the coupon holding component is plural coupon holding components.

11. The purse-like container of claim 8, further comprising a label area at top of a multitude of file areas in the accordion type coupon holding component.

12. The purse-like container of claim 1, further comprising a retainer attached to the housing to hold a hanger member.

13. The purse-like container of claim 12, wherein the retainer is a loop and a key ring to hold members that have openings cooperative with said loop.

15. The purse-like container of claim 2, wherein the coupon holding component includes a number of pocket-like or file-like units; and
the pocket-like or file-like units have a number of expandable vacant or hollow volumes;
wherein the pocket-like or file like units are fastened together to form an integral structure; and
the pocket-like or file like units are individually labeled.

16. A method of shopping, comprising:
suspending a purse-like container from the handle of a shopping cart, wherein the purse-like container has a number of coupons organized in a manner to facilitate coordinating access to the coupons with possible items for purchasing.

17. The method of claim 16, further comprising:
remaining coupons from the purse-like container corresponding to items to be purchased; and
using such coupons during purchasing.
